(19) United States
(12) Patent Application Publication
(10) Pub. No.: US 2009/0093357 A1
(43) Pub. Date: Apr. 9, 2009

(54) OPTICAL GLASS AND LENS USING THE SAME

(75) Inventors: Jun SASAI, Tokyo (JP); Naoki Sugimoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Tokyo (JP)

(21) Appl. No.: 12/332,589

(22) Filed: Dec. 11, 2008

Related U.S. Application Data
(63) Continuation of application No. PCT/JP07/61743, filed on Jun. 11, 2007.

(30) Foreign Application Priority Data
Jun. 13, 2006 (JP) 2006-163458

(51) Int. Cl. C03C 3/068

(52) U.S. Cl. 501/78

(57) ABSTRACT

The invention provides: an optical glass which comprises, in terms of % by mass on the basis of oxides, 13-27% of B₂O₃, 20-35% of La₂O₃, 5-25% of Gd₂O₃, 5-20% of ZnO, 0.5-3% of Li₂O, 0.5-15% of Ta₂O₅ and 0.5-10% of WO₃, wherein the value of (SiO₂+B₂O₃)/(ZnO+Li₂O), which is the mass ratio of the total content of SiO₂ and B₂O₃ to the total content of ZnO and Li₂O, is 1.35-1.65; and a lens comprising the optical glass.

### TECHNICAL FIELD

The present invention relates to an optical glass having a high refractive index and low-dispersion characteristics and to a lens using the glass.

### BACKGROUND ART

With the recent spread of high-resolution small digital cameras, cell phones fitted with a camera, and the like, there is a rapidly growing desire for weight and size reductions in the optical system. Optical design using an aspherical lens made of a highly functional glass has come to be mainly employed in order to meet the desire. In particular, large-aperture aspherical lenses formed from a glass having a high refractive index and low-dispersion characteristics have become important in optical design.

A glass comprising B₂O₃ and La₂O₃ as main components has hitherto been known as a glass having a high refractive index and showing low-dispersion characteristics. However, this glass generally has a high molding temperature and, hence, has had problems that the noble-metal protective film formed on WC type mold bases has a short life and the forming molds have a short durability life and that the glass necessitates a prolonged molding cycle, resulting in low productivity.

A glass containing Li₂O as a main component besides B₂O₃ and La₂O₃ is known which is intended to overcome those problems. However, there has been a problem that this glass is apt to devitrify during a high-temperature forming process because it contains rare-earth elements such as La₂O₃ in a large amount.

For producing an aspherical lens, the precision press molding method which is for producing a lens to be used as it is without pressed-side polishing has come to be mainly employed from the standpoints of productivity and production cost. In precision press molding, as the press molding temperature becomes lower, mold durability improves and the molding cycle becomes shorter, resulting in an increase in productivity. Because of this, an optical glass having a low molding temperature is desired.

When the content of an alkali metal or alkaline earth metal ingredient as a glass component is increased in order to lower a forming temperature, the thermal expansion coefficient of the optical glass increases. Since the WC, ceramic, or the like used as molds has a considerably lower thermal expansion coefficient than optical glasses, a thermal strain attributable to a difference in the thermal expansion coefficient between the mold and the optical glass is generated in the optical part as a molded article during forming. The forming strain changes the optical properties and, in the worst case, causes the molded article to develop a defect, e.g., a crack. Consequently, optical glasses are required to have both a lower forming temperature and a small thermal expansion coefficient.

A glass which comprises B₂O₃—SiO₂—La₂O₃—Gd₂O₃—ZnO—Li₂O—ZrO₂ as main components and in which n_{d} is 1.75-1.85 and ν_{d} is 40-55 is proposed in patent document 1 in order to overcome the problems described above. However, this glass has a problem that the forming temperature thereof is high.

A glass which comprises B₂O₃—La₂O₃—Gd₂O₃—ZnO—Li₂O as essential components, has an n_{d} of 1.68-1.8, ν_{d} of 44-53, and yield point of 630° C. or lower, and has a high refractive index and low-dispersion characteristics is proposed in patent document 2. However, this glass has had a problem concerning devitrification characteristics in a high-temperature forming process.

Furthermore, an optical glass for press molding which comprises B₂O₃—La₂O₃—ZnO—Ta₂O₅—WO₃ as main components and has an n_{d} of 1.75-1.85, ν_{d}≧35, and softening point of 700° C. or lower is proposed in patent document 3. However, this glass is still insufficient in balance among optical properties, formability, and low thermal expansibility.

Patent Document 1: JP-A-2003-201143

Patent Document 2: Japanese Patent No. 3458462

Patent Document 3: JP-A-2005-15302

### DISCLOSURE OF THE INVENTION

### Problems to be Solved by the Invention

An object of the invention is to provide an optical glass which has optical properties including a high refractive index and low-dispersion characteristics, has a low molding temperature, is less apt to devitrify, and has excellent formability.

### Means for Solving the Problems

The present inventors made intensive investigations on the problems described above. As a result, they have found that the object can be accomplished with the following optical glass and lens. The invention has been thus completed. The invention provides the following optical glass and lens.

(1) An optical glass which comprises, in terms of % by mass on the basis of oxides, 13-27% of B₂O₃, 20-35% of La₂O₃, 5-25% of Gd₂O₃, 5-20% of ZnO, 0.5-3% of Li₂O, 0.5-15% of Ta₂O₅ and 0.5-10% of WO₃, wherein the value of (SiO₂+B₂O₃)/(ZnO+Li₂O), which is the mass ratio of the total content of SiO₂ and B₂O₃ to the total content of ZnO and Li₂O, is 1.35-1.65.

(2) The optical glass as described under (1) which has a refractive index n_{d} of 1.75-1.80 and an Abbe number ν_{d} of 43-48.

(3) The optical glass as described under (2) wherein the n_{d} and the ν_{d} satisfy the relationship: n_{d}≧2.22−0.01×ν_{d}.

(4) The optical glass as described under (1), (2), or (3) which has a value of molding temperature (Tₚ) of 640° C. or lower, the molding temperature (Tₚ) being defined by the relational expression: At+(At−T_{g})/2 concerning glass transition point (T_{g}) and yield point (At), and has a liquidus temperature (T_{L}) of 1,000° C. or lower.

(5) The optical glass as described under any one of (1) to (4) which has an average thermal expansion coefficient (α) of 66×10⁻⁷ to 84×10⁻⁷K⁻¹.

(6) A lens comprising the optical glass as described under any one of (1) to (5).

### ADVANTAGES OF THE INVENTION

The optical glass of the invention (hereinafter referred to as “glass of the invention”) has a high refractive index, preferably a refractive index n_{d} of 1.75-1.80, and has low-dispersion characteristics, preferably an Abbe number ν_{d} of 43-48. The glass of the invention preferably is one in which the refractive index and the Abbe number satisfy the relationship: n_{d}≧2.22−0.01×ν_{d}, whereby the glass has an especially satisfactory balance between refractive index and dispersion characteristics.

Furthermore, the glass of the invention has a molding temperature as low as 650° C. and has a liquidus temperature, which is the highest temperature not causing devitrification, as low as 1,000° C. or below. Consequently, the glass has excellent press formability. Moreover, the glass of the invention has an average thermal expansion coefficient α of 66-84 (×10⁻⁷ K⁻¹), which is lower than those of optical glasses of the same kind. Because of this, the difference in the thermal expansion coefficient between this glass and any of pressing molds such as WC type ones is small, whereby the percentage of molded-article rejects attributable to a thermal strain can be considerably reduced. In addition, due to these advantages, optical products such as lenses can be produced with satisfactory productivity. The glass of the invention hence contributes also to a reduction in production cost.

### BEST MODE FOR CARRYING OUT THE INVENTION

The reasons for the limitation of each ingredient amount range in the glass of the invention are explained below.

B₂O₃ in the glass of the invention is an ingredient which forms a glass framework and lowers liquidus temperature T_{L}. It is an essential ingredient. The content of B₂O₃ in the glass of the invention is 13-27% by mass (hereinafter “% by mass” is abbreviated to “%”). In case where the B₂O₃ content is lower than 13%, vitrification is difficult or this glass has an elevated liquidus temperature T_{L}. From the standpoint of lowering the liquidus temperature T_{L}, it is preferred to regulate the B₂O₃ content to 15% or higher. The B₂O₃ content is more preferably regulated to 16% or higher, even more preferably regulated to 17% or higher. When the B₂O₃ content is 18% or higher, this glass has a lowered liquidus temperature and can have an Abbe number increased to 44-47.5. Such B₂O₃ contents are hence especially preferred.

On the other hand, in case where the B₂O₃ content in the glass of the invention exceeds 27%, there is a possibility that this glass might have a reduced refractive index n_{d} or be reduced in chemical durability, e.g., water resistance. In the glass of the invention, the B₂O₃ content is preferably 25% or lower. When the refractive index n_{d} is desired to be increased to 1.76-1.80, it is preferred to regulate the B₂O₃ content to 23% or lower. More preferably, the B₂O₃ content is regulated to 22% or lower.

ZnO in the glass of the invention is an ingredient which stabilizes the glass and lowers molding temperature or melting temperature. It is an essential ingredient. The content of ZnO in the glass of the invention is 5-20%. In case where the ZnO content is lower than 5%, there is a possibility that this glass might become unstable or have an elevated molding temperature. The ZnO content is preferably 7% or higher, more preferably 9% or higher. On the other hand, in case where the ZnO content in the glass of the invention exceeds 20%, there is a possibility that this glass might have impaired stability and reduced chemical durability. The ZnO content is preferably 19% or lower. More preferably, the ZnO content is 18% or lower.

La₂O₃ in the glass of the invention is an ingredient which increases refractive index n_{d} and improves chemical durability. It is an essential ingredient. The content of La₂O₃ in the glass of the invention is 20-35%. In case where the La₂O₃ content is lower than 20%, there is a possibility that this glass might have too low a refractive index n_{d}. The La₂O₃ content is preferably 22% or higher. More preferably, the La₂O₃ content is 24% or higher. On the other hand, in case where the La₂O₃ content exceeds 35%, vitrification is less apt to occur and there is a possibility that this glass might have an elevated molding temperature and an elevated liquidus temperature T_{L}. The La₂O₃ content is preferably 33% or lower. More preferably, the La₂O₃ content is 31% or lower.

Gd₂O₃ in the glass of the invention is an ingredient which increases refractive index n_{d} and improves chemical durability, like La₂O₃. It is an essential ingredient. The content of Gd₂O₃ in the glass of the invention is 5-25%. In case where the Gd₂O₃ content is lower than 5%, this glass has a reduced refractive index n_{d}. The Gd₂O₃ content is preferably 8% or higher. More preferably, the Gd₂O₃ content is 10% or higher. On the other hand, in case where the Gd₂O₃ content exceeds 25%, vitrification is less apt to occur and there is a possibility that this glass might have an elevated molding temperature or an elevated liquidus temperature T_{L}. The Gd₂O₃ content is preferably 22% or lower. More preferably, the Gd₂O₃ content is 19% or lower.

In the glass of the invention, the sum of the La₂O₃ content and the Gd₂O₃ content is preferably 35-50%. In case where that sum is less than 35%, there is a possibility that this glass might have a reduced refractive index n_{d} or reduced chemical durability. That sum is preferably 38% or more. More preferably, that sum is 40% or more. On the other hand, in case where that sum exceeds 50%, vitrification is less apt to occur and there is a possibility that this glass might have an elevated molding temperature or an elevated liquidus temperature T_{L}. That sum is preferably 47% or less. More preferably, that sum is 45% or less.

Li₂O in the glass of the invention is an ingredient which stabilizes the glass and lowers molding temperature or melting temperature. It is an essential ingredient. The content of Li₂O in the glass of the invention is 0.5-3%. In case where the Li₂O content is lower than 0.5%, there is a possibility that this glass might have too high a molding temperature or melting temperature. The Li₂O content is preferably 1.1% or higher. More preferably, the Li₂O content is 1.3% or higher. On the other hand, in case where the Li₂O content exceeds 3%, devitrification is apt to occur and there is a possibility that this glass might have considerably reduced chemical durability or undergo considerable ingredient volatilization during melting. The Li₂O content is preferably 2.5% or lower. More preferably, the Li₂O content is 2.3% or lower.

Ta₂O₅ in the glass of the invention is an ingredient which stabilizes the glass, increases refractive index n_{d}, and inhibits devitrification during high-temperature forming. It is an essential ingredient. The content of Ta₂O₅ in the glass of the invention is 0.5-15%. In case where the Ta₂O₅ content is lower than 0.5%, there is a possibility that this glass might have too low a refractive index n_{d} or too high a liquidus temperature T_{L}. The Ta₂O₅ content is preferably 1.5% or higher. More preferably, the Ta₂O₅ content is 2.5% or higher. On the other hand, in case where the Ta₂O₃ content exceeds 15%, there is a possibility that this glass might have too high a molding temperature or too small an Abbe number ν_{d}. The Ta₂O₅ content is preferably 13% or lower. More preferably, the Ta₂O₅ content is 12% or lower.

WO₃ in the glass of the invention is an ingredient which stabilizes the glass, increases refractive index n_{d}, and inhibits devitrification during high-temperature forming. It is an essential ingredient. The content of WO₃ in the glass of the invention is 0.5-10%. In case where the WO₃ content is lower than 0.5%, there is a possibility that this glass might have a reduced refractive index n_{d} or an elevated liquidus temperature T_{L}. The WO₃ content is preferably 1.5% or higher. More preferably, the WO₃ content is 2.5% or higher. On the other hand, in case where the WO₃ content exceeds 10%, there is a possibility that this glass might have an elevated molding temperature and a reduced Abbe number ν_{d}. The WO₃ content is preferably 8% or lower. More preferably, the WO₃ content is 7% or lower.

SiO₂ is not an essential ingredient in the glass of the invention. However, the glass may contain SiO₂ in an amount of 0-15% so as to be stabilized or inhibited from devitrifying during high-temperature forming or for another purpose. In case where the content of SiO₂ exceeds 15%, there is a possibility that this glass might have too high a molding temperature or too low a refractive index n_{d}. The SiO₂ content is more preferably 12% or lower. Even more preferably, the SiO₂ content is 10% or lower. On the other hand, when it is desired to inhibit devitrification during high-temperature forming or to regulate viscosity, it is preferred that the SiO₂ content should be 2% or higher. More preferably, the SiO₂ content is 4% or higher.

The present inventors have found that a low molding temperature can be reconciled with a low liquidus temperature by regulating the mass ratio of the sum of the contents of B₂O₃ and SiO₂, which are oxide ingredients forming a glass network, to the sum of the contents of Li₂O and ZnO, which are mono- or divalent glass-modifying oxide ingredients, i.e., (SiO₂+B₂O₃)/(ZnO+Li₂O) (hereinafter referred to as “network modification ratio”), to a specific value.

In the glass of the invention, the network modification ratio is 1.35-1.65. In case where the network modification ratio is lower than 1.35 or exceeds 1.65, it is difficult to reconcile a low molding temperature with a low liquidus temperature. The lower limit of the network modification ratio is more preferably 1.38 or higher, even more preferably 1.40 or higher. On the other hand, the upper limit of the network modification ratio is more preferably 1.64 or lower, even more preferably 1.63 or lower.

ZrO₂ is not an essential ingredient in the glass of the invention. However, the glass may contain ZrO₂ in an amount of 0-5% so as to be stabilized, increased in refractive index n_{d}, or inhibited from devitrifying during high-temperature forming or for another purpose. In case where the content of ZrO₂ exceeds 5%, there is a possibility that this glass might have too high a molding temperature or too small an Abbe number ν_{d}. The ZrO₂ content is more preferably 4% or lower. Even more preferably, the ZrO₂ content is 3% or lower. On the other hand, from the standpoint of obtaining the effects of addition, the ZrO₂ content is more preferably 0.2% or higher. Even more preferably, the ZrO₂ content is 0.4% or higher.

TiO₂ is not an essential ingredient in the glass of the invention. However, the glass may contain TiO₂ in an amount of 0-5% so as to be stabilized, increased in refractive index n_{d}, or inhibited from devitrifying during high-temperature forming or for another purpose. In case where the content of TiO₂ exceeds 5%, there is a possibility that this glass might have too small an Abbe number ν_{d} or a reduced transmittance. The TiO₂ content is more preferably 3% or lower.

Nb₂O₅ is not an essential ingredient in the glass of the invention. However, the glass may contain Nb₂O₅ in an amount of 0-10% so as to be stabilized, increased in refractive index n_{d}, or inhibited from devitrifying during high-temperature forming or for another purpose. In case where the content of Nb₂O₅ exceeds 10%, there is a possibility that this glass might have too small an Abbe number ν_{d} or a reduced transmittance. The Nb₂O₅ content is more preferably 7% or lower.

Y₂O₃ and Yb₂O₃ each are not an essential ingredient in the glass of the invention. However, the glass may contain these ingredients in an amount of 0-10% so as to be increased in refractive index n_{d} or inhibited from devitrifying during high-temperature forming or for another purpose. In case where the content of these ingredients exceeds 10%, there is a possibility that this glass might become unstable rather than stable or have too high a molding temperature. The content of Y₂O₃ and Yb₂O₃ is preferably 7% or lower.

Al₂O₃, Ga₂O₃, GeO₂, and P₂O₅ each are not an essential ingredient in the glass of the invention. However, the glass may contain these ingredients in an amount of 0-10% so as to be stabilized or have a regulated refractive index n_{d} or for another purpose. In case where the content of Al₂O₃, Ga₂O₃, GeO₂, and P₂O₅ exceeds 10%, there is a possibility that this glass might have too small an Abbe number. The content of Al₂O₃, Ga₂O₃, GeO₂, and P₂O₅ is more preferably 8% or lower, even more preferably 6% or lower.

In the case where the glass of the invention contains SiO₂, Al₂O₃, Ga₂O₃, and GeO₂, it is preferred that the sum of the contents of SiO₂, Al₂O₃, Ga₂O₃, and GeO₂ and the content of B₂O₃ should be 15-35%. In case where that sum is smaller than 15%, there is a possibility that vitrification might become difficult or this glass might have an elevated liquidus temperature T_{L}. That sum is more preferably 18% or larger. Even more preferably, that sum is 22% or larger.

On the other hand, in case where the sum of the contents of SiO₂, Al₂O₃, Ga₂O₃, GeO₂, and B₂O₃ exceeds 35%, there is a possibility that this glass might have a reduced refractive index n_{d} or an elevated molding temperature. That sum is more preferably 32% or smaller. Even more preferably, that sum is 29% or smaller.

BaO, SrO, CaO, and MgO each are not an essential ingredient in the glass of the invention. However, the glass may contain these ingredients each in an amount of 0-15% so as to be stabilized or have an increased Abbe number ν_{d}, lowered molding temperature, or reduced specific gravity or for another purpose. In case where the content of each of BaO, SrO, CaO, and MgO exceeds 15%, there is a possibility that this glass might become unstable or have a reduced refractive index n_{d}, etc.

In the case where the glass contains BaO, SrO, CaO, and MgO, it is desirable that the sum of the contents of BaO, SrO, CaO, and MgO and the content of ZnO should be 5-25%. In case where that sum is smaller than 5%, this glass is unstable or has too high a molding temperature. That sum is more preferably 8% or larger. Even more preferably, that sum is 10% or larger. On the other hand, in case where that sum exceeds 25%, there is a possibility that this glass might become unstable rather than stable or have a reduced refractive index n_{d}, reduced chemical durability, etc. That sum is more preferably 21% or smaller. Even more preferably, that sum is 18% or smaller.

In the case where the glass of the invention is desired, for example, to be more inhibited from devitrifying in high-temperature forming, it is preferred that the glass should comprise 15-25% of B₂O₃, 22-33% of La₂O₃, 8-22% of Gd₂O₃, 7-19% of ZnO, 1.1-2.5% of Li₂₀, 1.5-13% of Ta₂O₅ and 1.5-8% of WO₃, and have a network modification ratio of 1.38-1.64. To further incorporate 2-12% of SiO₂ or 0.2-4% of ZrO₂ and/or TiO₂ into that composition is preferred because this incorporation enables the devitrification-inhibiting effect to be produced with higher certainty.

Although the glass of the invention essentially comprises the ingredients described above, it may contain other ingredients as long as this does not defeat the object of the invention. When the glass contains other ingredients, the total content of these ingredients is preferably 10% or lower, more preferably 8% or lower, even more preferably 6% or lower.

For example, for the purpose of refining, etc., Sb₂O₃ may be contained in the glass of the invention in an amount of, e.g., 0-1%. Furthermore, for the purpose of more stabilizing the glass, regulating the refractive index n_{d}, regulating the specific gravity, lowering the melting temperature, etc., the glass may contain each of Na₂O, K₂O, Rb₂O, and Cs₂O in a total amount of 0-5%. In case where the total amount of Na₂O, K₂O, Rb₂O, and Cs₂O exceeds 5%, there is a possibility that the glass might become unstable or have a reduced refractive index n_{d}, reduced hardness, or reduced chemical durability. In the case where hardness or chemical durability is regarded as important, it is preferred that the glass should contain none of Na₂O, K₂O, Rb₂O, and Cs₂O.

In the glass of the invention, optional ingredients other than those shown above can be selected according to individual properties required. For example, when a high refractive index n_{d} and a low glass transition point T_{g} are regarded as important, SnO₂ may be contained in an amount of 0-4%. Likewise, when a high refractive index is regarded as important, TeO₂ and/or Bi₂O₃ may be contained singly or in combination in a total amount of 0-6%. In case where the content of TeO₂ and/or BiO₃ exceeds 6%, there is a possibility that the glass might become unstable or have a considerably reduced transmittance. It is, however, noted that when the Abbe number ν_{d} is desired to be increased, it is preferred that the glass should contain neither TeO₂ nor Bi₂O₃.

From the standpoint of reducing an environmental burden, it is preferred that the glass of the invention should contain substantially none of lead (PbO), arsenic (As₂O₃), and thallium (Tl₂O). Furthermore, when fluorine is contained, this not only increases the thermal expansion coefficient and exerts an adverse influence on releasability and formability but also is apt to result in ingredient volatilization. There are hence problems, for example, that this optical glass is apt to have a heterogeneous composition and reduces the durability of molds including release films. It is therefore preferred that the glass of the invention should contain substantially no fluorine also.

From the standpoints of preventing coloration, etc., it is preferred that the glass of the invention should contain no Fe₂O₃. Usually, however, Fe₂O₃ unavoidably comes into the glass from raw materials. Even in this case, the content of Fe₂O₃ in the glass of the invention is preferably regulated to 0.0001% or lower.

With respect to optical properties of the glass of the invention, the refractive index n_{d} thereof is preferably 1.75-1.80. In case where the refractive index n_{d} thereof is lower than 1.75, this glass is unsuitable for lens miniaturization. The refractive index n_{d} thereof is more preferably 1.76 or higher. On the other hand, refractive indexes n_{d} of the glass exceeding 1.80 are undesirable because this results in too small an Abbe number. The refractive index n_{d} of the glass of the invention is more preferably 1.79 or lower. When the refractive index n_{d} of the glass of the invention is 1.75-1.80, the Abbe number ν_{d} thereof is preferably 43-48. When the refractive index n_{d} of the glass of the invention is 1.76-1.79, the Abbe number ν_{d} thereof is more preferably 44-47.

In the glass of the invention, when the refractive index n_{d} has a specific relationship with the Abbe number ν_{d}, this glass is preferred from the standpoint of optical design because the two properties are balanced. Specifically, it is preferred that when the Abbe number ν_{d} and the refractive index n_{d} are plotted on two-dimensional coordinates, then the optical-property points for the glass of the invention should be in the region which is above the straight line (n_{d}=2.22−0.01×ν_{d}) connecting (ν_{d}, n_{d})=(43, 1.79) and (ν_{d}, n_{d})=(48, 1.74) (i.e., in the region where n_{d}≧2.22−0.01×ν_{d}). It is more preferred that the optical-property points for the glass of the invention should be in the region which is above the straight line (n_{d}=2.316−0.012×ν_{d}) connecting (ν_{d}, n_{d})=(43, 1.80) and (ν_{d}, n_{d})=(48, 1.74) (i.e., in the region where n_{d}≧2.316−0.012×ν_{d}).

In this specification, molding temperature Tₚ means the value calculated from glass transition temperature T_{g} and yield point At by Tₚ=At+(At−T_{g})/2.

The molding temperature Tₚ of the glass of the invention is preferably 640° C. or lower because such a molding temperature facilitates precision press molding. In case where the molding temperature Tₚ thereof exceeds 640° C., there is a possibility that part of the components of the preform to be formed might volatilize during press molding to cause damage to the mold material and release film and thereby reduce the durability of the mold. In addition, there is a possibility that the productivity in press molding itself might decrease. The molding temperature Tₚ of the glass of the invention is more preferably 635° C. or lower, even more preferably 630° C. or lower.

The thermal expansion coefficient of the optical glass is preferably 66×10⁻⁷ to 84×10⁻⁷ K⁻¹ in terms of the average degree of thermal expansion α. This is because the smaller the difference in the average thermal expansion coefficient between the mold and the optical glass, the more the optical glass is preferred; the average thermal expansion coefficient of, for example, the WC type mold is 40×10⁻⁷ to 50×10⁻⁷ K⁻¹. In case where the average thermal expansion coefficient α of the glass of the invention exceeds 84×10⁻⁷ K⁻¹, this glass is apt to develop defects, e.g., a crack, during press molding. When milder pressing conditions are used in order to avoid cracking or the like, sinking occurs, resulting in reduced shape transferability, etc. The average thermal expansion coefficient α of the glass of the invention is more preferably 83×10⁻⁷ K⁻¹ or lower, even more preferably 82×10⁻⁷ K⁻¹ or lower.

On the other hand, in case where the optical glass has too low an average thermal expansion coefficient α, there is a possibility that the optical part might be difficult to release from the mold during the cooling step in press molding and, in the worst case, the optical part might adhere to the mold, resulting in a defective molded article. Consequently, the average thermal expansion coefficient α of the glass of the invention is preferably 66×10⁻⁷ K⁻¹ or higher. The average thermal expansion coefficient α of the glass of the invention is more preferably 67×10⁻⁷ K⁻¹ or higher, even more preferably 68×10⁻⁷ K⁻¹ or higher. In this specification, the average thermal expansion coefficient α means the average coefficient of linear expansion in the temperature range of 50-350° C.

The liquidus temperature T_{L} of the glass of the invention is preferably 1,000° C. or lower. In case where the liquidus temperature T_{L} thereof exceeds 1,000° C., the material to be formed is apt to devitrify during high-temperature forming. The liquidus temperature T_{L} of the glass of the invention is more preferably 990° C. or lower, even more preferably 980° C. or lower. Liquidus temperature T_{L} is defined as the highest temperature which does not cause solid crystals to generate from the glass melt after holding at the temperature.

Since the glass of the invention has the properties described above, optical design is easy and the glass is suitable for use as optical parts, in particular, aspherical lenses for use in digital cameras, etc.

### EXAMPLES

Embodiments of the invention will be explained below by reference to Examples according to the invention (Examples 1 to 27) and Comparative Examples (Examples 28 to 32). However, the invention should not be construed as being limited to these.

As to a raw material preparation process, the raw materials shown below were mixed so as to obtain a glass having each of the compositions shown in the tables. The mixture was placed in a crucible made of platinum and melted at 1,100-1,300° C. for 1 hour. In this operation, the contents were stirred with a platinum stirrer for 0.5 hours to homogenize the molten glass. The molten glass homogenized was poured and formed into a plate shape. Thereafter, the plate was held at a temperature of T_{g}+10° C. for 4 hours and then gradually cooled to room temperature at a cooling rate −1° C./min. In the tables, each section indicated by “−” shows that the ingredient is absent.

The raw materials are as follows. As boron oxide, aluminum oxide, lithium carbonate, sodium carbonate, zirconium dioxide, zinc oxide, magnesium oxide, calcium carbonate, barium carbonate, strontium carbonate, and antimony oxide, use was made of the special-grade reagents manufactured by Kanto Chemical Co., Inc. As lanthanum oxide, gadolinium oxide, and yttrium oxide, use was made of the reagents having a purity of 99.9% manufactured by Shin-Etsu Chemical Co., Ltd. As tantalum oxide, silicon dioxide, tungsten oxide, niobium oxide, and bismuth oxide, use was made of the reagents having a purity of 99.9% or higher manufactured by Kojundo Chemical Laboratory Co., Ltd.

The glasses obtained were examined for glass transition point T_{g}, yield point At (unit: ° C.), average coefficient of linear expansion α at 50-350° C. (unit: 10⁻⁷ K⁻¹), refractive index n_{d} at a wavelength of 587.6 nm (d-line), Abbe number ν_{d}, liquidus temperature T_{L} (unit: ° C.), and specific gravity d. Methods for these examinations are as follows.

Thermal Properties (T_{g}, At, and α): A sample processed into a cylindrical shape having a diameter of 5 mm and a length of 20 mm was examined with a thermomechanical analyzer (trade name, DILATOMETER 5000; manufactured by MAC Science Co., Ltd.) at a heating rate of 5° C./min.

Optical Properties (n_{d} and ν_{d}): A sample processed into a rectangular shape having a side length of 20 mm and a thickness of 10 mm was examined with a precision refractometer (trade name, KPR-2; manufactured by Kalnew Co., Ltd.). The samples in which n_{d} and ν_{d} satisfy the relationship: n_{d}≧2.22−0.01×ν_{d} are indicated by A, while those in which the relationship is not satisfied are indicated by B. Measured values were determined to five decimal places. Each value of refractive index n_{d} was one obtained by rounding off the found value by correcting to nearest hundredth, while each value of Abbe number ν_{d} was one obtained by rounding off the found value by correcting to nearest tenth.

Liquidus Temperature T_{L}: A sample processed into a cubic shape having a side length of 10 mm was placed on a disk made of platinum. This sample on the dish was allowed to stand still for 1 hour in an electric furnace set at a given temperature and then taken out. This sample was examined with an optical microscope having a magnification of 10 diameters. The highest temperature which did not cause crystal precipitation was taken as T_{L}. The sample which had a liquidus temperature T_{L} exceeding 1,000° C. is indicated by “>1000”.

Specific gravity: A sample processed into a rectangular shape having a side length of 20 mm and a thickness of 10 mm was examined with a precision gravimeter (trade name, SGM 300P; manufactured by Shimadzu Corp.).

With respect to devitrification characteristics, the glasses which show no devitrification precipitate at a liquidus temperature of 1,000° C. are indicated by A, while that which shows a devitrification precipitate is indicated by B.

TABLE 1

| | No. | | | | |
|---|---|---|---|---|---|
| | Example 1 | Example 2 | Example 3 | Example 4 | Example 5 |
| B₂O₃ | 20.8 | 20.7 | 19.5 | 19.6 | 19.7 |
| SiO₂ | 4.5 | 4.5 | 6.2 | 5.4 | 5.4 |
| La₂O₃ | 25.4 | 27.9 | 25.3 | 25.5 | 28 |
| Gd₂O₃ | 17.5 | 14.9 | 17.4 | 17.6 | 14.9 |
| ZnO | 15 | 15.1 | 14.9 | 15 | 15.1 |
| Li₂O | 1.7 | 1.7 | 1.7 | 1.7 | 1.7 |
| ZrO₂ | 1.8 | 1.8 | 1.8 | 1.8 | 1.8 |
| Ta₂O₅ | 9.9 | 9.9 | 9.8 | 9.9 | 9.9 |
| WO₃ | 3.4 | 3.5 | 3.4 | 3.5 | 3.5 |
| (SiO₂ + B₂O₃)/(Li₂O + ZnO) | 1.51 | 1.50 | 1.55 | 1.50 | 1.49 |
| Refractive index n_{d} | 1.78 | 1.78 | 1.78 | 1.79 | 1.79 |
| Abbe number ν_{d} | 45.5 | 45.8 | 46.1 | 45.6 | 45.6 |
| Glass transition point T_{g}/° C. | 553 | 556 | 561 | 558 | 557 |
| Yield point Aₜ/° C. | 607 | 607 | 611 | 609 | 608 |
| Liquidus temperature T_{L}/° C. | 990 | 980 | 980 | 1000 | 980 |
| Coefficient of thermal expansion α | 79.2 | 79.5 | 78.5 | 79.4 | 79.7 |
| Specific gravity | 4.69 | 4.67 | 4.68 | 4.71 | 4.69 |
| Molding temperature Tₚ/° C. | 633 | 632 | 637 | 634 | 633 |
| nd ≧ 2.22 − 0.01 × νd | A | A | A | A | A |
| Devitrification characteristics | A | A | A | A | A |

TABLE 2

| | No. | | | | |
|---|---|---|---|---|---|
| | Example 6 | Example 7 | Example 8 | Example 9 | Example 10 |
| B₂O₃ | 19.2 | 19.3 | 18.1 | 19.1 | 19.3 |
| SiO₂ | 6.09 | 6.08 | 7.83 | 6.02 | 6.12 |
| La₂O₃ | 24.9 | 27.3 | 27.1 | 27.0 | 27.3 |
| Gd₂O₃ | 17.1 | 14.5 | 14.4 | 14.4 | 14.5 |
| ZnO | 14.7 | 14.7 | 14.6 | 14.6 | 13.5 |
| Li₂O | 1.65 | 1.65 | 1.64 | 1.64 | 1.87 |
| ZrO₂ | 1.79 | 1.79 | 1.78 | 1.78 | 1.8 |
| Ta₂O₅ | 11.2 | 11.3 | 11.2 | 9.6 | 9.7 |
| WO₃ | 3.37 | 3.38 | 3.35 | 5.86 | 5.91 |
| (SiO₂ + B₂O₃)/(Li₂O + ZnO) | 1.55 | 1.55 | 1.60 | 1.55 | 1.65 |
| Refractive index n_{d} | 1.79 | 1.79 | 1.78 | 1.79 | 1.79 |
| Abbe number ν_{d} | 45.5 | 45.4 | 45.3 | 44.7 | 44.9 |
| Glass transition point T_{g}/° C. | 562 | 561 | 565 | 561 | 555 |
| Yield point Aₜ/° C. | 612 | 612 | 615 | 612 | 607 |
| Liquidus temperature T_{L}/° C. | 1000 | 970 | 980 | 960 | 970 |
| Coefficient of thermal expansion α | 78.5 | 78.8 | 78.2 | 77.8 | 78.9 |
| Specific gravity | 4.71 | 4.69 | 4.68 | 4.67 | 4.65 |
| Molding temperature Tₚ/° C. | 638 | 637 | 640 | 637 | 633 |
| nd ≧ 2.22 − 0.01 × νd | A | A | A | A | A |
| Devitrification characteristics | A | A | A | A | A |

TABLE 3

| | No. | | | | |
|---|---|---|---|---|---|
| | Example 11 | Example 12 | Example 13 | Example 14 | Example 15 |
| B₂O₃ | 19.5 | 19.7 | 19.7 | 19.5 | 19.2 |
| SiO₂ | 6.10 | 5.40 | 5.30 | 5.30 | 5.20 |
| La₂O₃ | 27.6 | 26.7 | 27.7 | 27.5 | 27.3 |
| Gd₂O₃ | 14.7 | 16.2 | 14.8 | 14.6 | 14.5 |
| ZnO | 13.7 | 15.1 | 14.9 | 14.8 | 14.7 |
| Li₂O | 1.89 | 1.70 | 1.70 | 1.70 | 1.70 |
| ZrO₂ | 1.81 | 1.80 | 1.80 | 1.80 | 1.80 |
| Ta₂O₅ | 11.3 | 9.90 | 9.80 | 9.70 | 9.70 |
| WO₃ | 3.40 | 3.50 | 4.30 | 5.10 | 5.90 |
| (SiO₂ + B₂O₃)/(Li₂O + ZnO) | 1.64 | 1.49 | 1.51 | 1.50 | 1.49 |
| Refractive index n_{d} | 1.78 | 1.79 | 1.79 | 1.79 | 1.79 |
| Abbe number ν_{d} | 45.6 | 45.6 | 45.2 | 44.9 | 44.5 |
| Glass transition point T_{g}/° C. | 556 | 557 | 557 | 558 | 558 |
| Yield point Aₜ/° C. | 607 | 608 | 608 | 609 | 609 |
| Liquidus temperature T_{L}/° C. | 980 | 990 | 980 | 980 | 980 |
| Coefficient of thermal expansion α | 79.9 | 79.5 | 79.4 | 79.0 | 78.6 |
| Specific gravity | 4.67 | 4.70 | 4.69 | 4.70 | 4.70 |
| Molding temperature Tₚ/° C. | 633 | 634 | 634 | 634 | 635 |
| nd ≧ 2.22 − 0.01 × νd | A | A | A | A | A |
| Devitrification characteristics | A | A | A | A | A |

TABLE 4

| | No. | | | | |
|---|---|---|---|---|---|
| | Example 16 | Example 17 | Example 18 | Example 19 | Example 20 |
| B₂O₃ | 19.9 | 19.7 | 20.5 | 20.1 | 20.1 |
| SiO₂ | 5.40 | 5.40 | 5.58 | 5.47 | 5.48 |
| La₂O₃ | 27.0 | 26.8 | 30.3 | 29.7 | 28.5 |
| Gd₂O₃ | 13.7 | 13.5 | 14.0 | 13.8 | 15.1 |
| ZnO | 15.2 | 15.1 | 15.6 | 15.4 | 15.3 |
| Li₂O | 1.70 | 1.70 | 1.76 | 1.73 | 1.72 |
| ZrO₂ | 1.90 | 1.80 | 1.91 | 1.87 | 1.87 |
| Ta₂O₅ | 10.0 | 9.90 | 6.76 | 8.40 | 8.41 |
| WO₃ | 5.20 | 6.10 | 3.59 | 3.53 | 3.52 |
| (SiO₂ + B₂O₃)/(Li₂O + ZnO) | 1.50 | 1.49 | 1.50 | 1.49 | 1.50 |
| Refractive index n_{d} | 1.78 | 1.79 | 1.78 | 1.78 | 1.78 |
| Abbe number ν_{d} | 45.1 | 44.8 | 46.2 | 45.9 | 45.9 |
| Glass transition point T_{g}/° C. | 556 | 557 | 554 | 555 | 556 |
| Yield point Aₜ/° C. | 607 | 608 | 605 | 606 | 607 |
| Liquidus temperature T_{L}/° C. | 950 | 950 | 1000 | 1000 | 990 |
| Coefficient of thermal expansion α | 77.9 | 77.5 | 80.0 | 79.9 | 79.8 |
| Specific gravity | 4.64 | 4.64 | 4.61 | 4.64 | 4.65 |
| Molding temperature Tₚ/° C. | 633 | 633 | 631 | 632 | 632 |
| nd ≧ 2.22 − 0.01 × νd | A | A | A | A | A |
| Devitrification characteristics | A | A | A | A | A |

TABLE 5

| | Exam- | Exam- | Exam- | Exam- |
|---|---|---|---|---|
| No. | ple 21 | ple 22 | ple 23 | ple 24 |
| B₂O₃ | 20.1 | 19.8 | 20.1 | 20.7 |
| SiO₂ | 5.49 | 5.36 | 5.49 | 5.60 |
| La₂O₃ | 29.7 | 29.2 | 28.4 | 27.9 |
| Gd₂O₃ | 13.8 | 13.6 | 15.1 | 14.1 |
| ZnO | 15.3 | 15.1 | 15.3 | 15.7 |
| Li₂O | 1.73 | 1.70 | 1.72 | 1.77 |
| ZrO₂ | 1.87 | 1.84 | 1.87 | 1.92 |
| Ta₂O₅ | 6.72 | 8.20 | 6.74 | 6.89 |
| WO₃ | 5.29 | 5.20 | 5.28 | 5.42 |
| (SiO₂ + B₂O₃)/(Li₂O + ZnO) | 1.50 | 1.50 | 1.50 | 1.51 |
| Refractive index n_{d} | 1.78 | 1.79 | 1.78 | 1.78 |
| Abbe number ν_{d} | 45.5 | 45.2 | 45.5 | 45.8 |
| Glass transition point T_{g}/° C. | 554 | 556 | 555 | 553 |
| Yield point Aₜ/° C. | 606 | 607 | 606 | 605 |
| Liquidus temperature T_{L}/° C. | 990 | 1000 | 1000 | 950 |
| Coefficient of thermal expansion α | 79.2 | 79.2 | 79.1 | 78.0 |
| Specific gravity | 4.62 | 4.65 | 4.63 | 4.56 |
| Molding temperature Tₚ/° C. | 632 | 633 | 632 | 631 |
| nd ≧ 2.22 − 0.01 × νd | A | A | A | A |
| Devitrification characteristics | A | A | A | A |

TABLE 6

| | Example | Example | Example |
|---|---|---|---|
| No. | 25 | 26 | 27 |
| B₂O₃ | 21.5 | 20.9 | 21.7 |
| SiO₂ | 5.30 | 5.72 | 5.82 |
| La₂O₃ | 29.1 | 28.3 | 29.4 |
| Gd₂O₃ | 14.7 | 14.3 | 14.9 |
| ZnO | 16.4 | 16.0 | 16.5 |
| Li₂O | 1.84 | 1.80 | 1.86 |
| ZrO₂ | 2.00 | 0.49 | 0.50 |
| Ta₂O₅ | 3.58 | 6.99 | 3.62 |
| WO₃ | 5.58 | 5.50 | 5.70 |
| (SiO₂ + B₂O₃)/(Li₂O + ZnO) | 1.47 | 1.50 | 1.50 |
| Refractive index n_{d} | 1.77 | 1.77 | 1.76 |
| Abbe number ν_{d} | 46.4 | 46.2 | 46.9 |
| Glass transition point T_{g}/° C. | 549 | 549 | 546 |
| Yield point Aₜ/° C. | 601 | 601 | 599 |
| Liquidus temperature T_{L}/° C. | 1000 | 960 | 960 |
| Coefficient of thermal expansion α | 78.4 | 78.5 | 78.6 |
| Specific gravity | 4.50 | 4.57 | 4.50 |
| Molding temperature Tₚ/° C. | 627 | 627 | 625 |
| nd ≧ 2.22 − 0.01 × νd | A | A | A |
| Devitrification characteristics | A | A | A |

TABLE 7

| | No. | | | | |
|---|---|---|---|---|---|
| | Example 28 | Example 29 | Example 30 | Example 31 | Example 32 |
| SiO₂ | 4.20 | 1.00 | — | 7.18 | 4.78 |
| B₂O₃ | 17.1 | 25.7 | 30.0 | 20.8 | 23.1 |
| Al₂O₃ | 2.50 | — | — | — | — |
| Li₂O | 0.50 | 1.90 | 2.50 | 1.79 | 1.19 |
| Na₂O | 1.90 | — | — | — | — |
| ZrO₂ | 1.20 | 6.90 | — | 3.27 | 3.92 |
| ZnO | 19.8 | 5.90 | 17.5 | 13.0 | 14.1 |
| La₂O₃ | 21.0 | 41.1 | 25.0 | 26.0 | 24.2 |
| Gd₂O₃ | 9.80 | — | 10.0 | 19.2 | 21.7 |
| Y₂O₃ | — | 2.00 | — | — | — |
| MgO | — | — | 5.00 | — | — |
| CaO | 2.20 | — | — | — | — |
| BaO | 2.80 | 1.00 | — | — | — |
| SrO | 1.20 | — | — | — | — |
| Nb₂O₅ | — | — | 10.0 | — | — |
| Ta₂O₅ | 14.0 | 14.3 | — | 8.80 | 7.05 |
| WO₃ | 1.20 | — | — | — | — |
| Bi₂O₃ | 0.50 | — | — | — | — |
| Sb₂O₃ | 0.10 | 0.20 | — | — | — |
| (SiO₂ + B₂O₃)/(Li₂O + ZnO) | 1.00 | 3.40 | 1.50 | 1.90 | 1.80 |
| Refractive index n_{d} | 1.76 | not | not | 1.77 | 1.77 |
| Abbe number ν_{d} | 45.9 | vitrified | vitrified | 47.6 | 47.9 |
| Glass transition point T_{g}/° C. | 542 | | | 570 | 587 |
| Yield point Aₜ/° C. | 597 | | | 620 | 634 |
| Liquidus temperature T_{L}/° C. | >1000 | | | 980 | 970 |
| Coefficient of thermal expansion α | 86.1 | | | 78.8 | 75.5 |
| Specific gravity | 4.53 | | | 4.59 | 4.62 |
| Molding temperature Tₚ/° C. | 624 | | | 645 | 658 |
| n_{d} ≧ 2.22 − 0.01 × ν_{d} | B | | | A | A |
| Devitrification characteristics | B | | | A | A |

While the invention has been described in detail and with reference to specific embodiments thereof, it will be apparent to one skilled in the art that various changes and modifications can be made therein without departing from the spirit and scope thereof.

This application is based on Japanese Patent Application No. 2006-163458 filed Jun. 13, 2006, the contents thereof being herein incorporated by reference.

### INDUSTRIAL APPLICABILITY

The glass of the invention is an optical glass which has balanced optical properties, preferably a refractive index n_{d} of 1.75-1.80 and an Abbe number ν_{d} of 43-48, and further has excellent formability. Thus, an optical glass suitable for use as optical parts for, e.g., digital cameras can be provided by the invention.

1. An optical glass which comprises, in terms of % by mass on the basis of oxides,
13-27% of B₂O₃,
20-35% of La₂O₃,
5-25% of Gd₂O₃,
5-20% of ZnO,
0.5-3% of Li₂O,
0.5-15% of Ta₂O₅, and
0.5-10% of WO₃
wherein the value of (SiO₂+B₂O₃)/(ZnO+Li₂O), which is the mass ratio of the total content of SiO₂ and B₂O₃ to the total content of ZnO and Li₂O, is 1.35-1.65.

2. The optical glass of claim 1, which has a refractive index n_{d} of 1.75-1.80 and an Abbe number ν_{d} of 43-48.

3. The optical glass of claim 2, wherein the n_{d} and the ν_{d} satisfy the relationship: n_{d}≧2.22−0.01×ν_{d}.

4. The optical glass of claim 1, which has a value of molding temperature (Tₚ) of 640° C. or lower, the molding temperature (Tₚ) being defined by the relational expression: At+(At−T_{g})/2 concerning glass transition point (T_{g}) and yield point (At), and has a liquidus temperature (T_{L}) of 1,000° C. or lower.

5. The optical glass of claim 1, which has an average thermal expansion coefficient (α) of 66×10⁻⁷ to 84×10⁻⁷ K⁻¹.

6. A lens comprising the optical glass of claim 1.
